(19) United States
(12) Patent Application Publication
(10) Pub. No.: US 2025/0286441 A1
(43) Pub. Date: Sep. 11, 2025

(54) Electric Motor

(71) Applicant: Innomotics GmbH, Nürnberg (DE)

(72) Inventor: Frank Brütting, Erlangen (DE)

(73) Assignee: Innomotics GmbH, Nürnberg (DE)

(21) Appl. No.: 18/858,379

(22) PCT Filed: Mar. 30, 2023
(86) PCT No.: PCT/EP2023/058318

§ 371 Date: Oct. 21, 2024

(30) Foreign Application Priority Data
Apr. 26, 2022 (EP) 22170036.2

(51) Int. Cl. H02K 9/22; H02K 9/193; H02K 11/33

(52) U.S. Cl. CPC H02K 9/225; H02K 9/193; H02K 11/33; H02K 2211/03

(57) ABSTRACT

Various embodiments of the teachings herein include an electric motor. An example includes: a stator having a plurality of bar-shaped field conductors; a plurality of inverters for actuating the field conductors; and a cooling apparatus including a fluid pipe externally adjacently guided on one or more of the field conductors. The inverters are arranged on one or more printed circuit boards arranged on at least one cooling plate. The at least one cooling plate is mechanically connected to the field conductors or conductors electrically connected to the field conductors.

### CROSS-REFERENCE TO RELATED APPLICATIONS

This application is a U.S. National Stage Application of International Application No. PCT/EP2023/058318 filed Mar. 30, 2023, which designates the United States of America, and claims priority to EP application Ser. No. 22/170,036.2 filed Apr. 26, 2022, the contents of which are hereby incorporated by reference in their entirety.

### TECHNICAL FIELD

The present disclosure relates to electric motors. Various embodiments of the teachings herein include an electric motor with a bar winding on the stator side.

### BACKGROUND

Electric motors can have a bar winding on the stator side. Here, the stator (stator) has a series of bars instead of wound wire conductors as field conductors. The bars have a low inductance compared to conventional windings. Therefore, a comparatively high current flow is necessary for generating a predefined magnetic field.

However, this high current flow requires only a comparatively low voltage of, for example, 12 v due to the low resistance of the bars. The low voltage makes it possible to arrange the components of the inverters, with which the bars are actuated, at small spacings from one another. The components of the power electronics can thus be arranged, for example, on one or more printed circuit board(s) which are arranged close to the electric motor. The bars can be used directly or via electrically conductive bar-like connecting elements directly as mechanical supports for the printed circuit boards.

The high heat loss of the electrical and electronic components, which is caused by the high current intensities, is therefore compounded by a high packing density of the electrical and electronic components in an electric motor configured in this way. The direct connection thereof to the stator/rotor block via bars provides for further heat input from the stator/rotor block. This disadvantageously results in a considerable cooling effort for the electrical and electronic components on the printed circuit board.

### SUMMARY

Teachings of the present disclosure include an electric motors which avoid the disadvantage mentioned in the introduction. For example, some embodiments include an electric motor (10) with: a stator (11) with a plurality of field conductors (12) embodied as bars (12), a plurality of inverters for actuating the field conductors (12), wherein the inverters are arranged on one or more printed circuit board(s) (15), the printed circuit boards (15) are arranged on at least one cooling plate (16), the cooling plate (16) is arranged such that the field conductors (12) or conductors (18) electrically connected to the field conductors (12) are mechanically operatively connected to the cooling plate, at least one cooling apparatus is present which comprises a fluid pipe (20, 60) which is externally adjacently guided on one or more of the field conductor(s) (12).

In some embodiments, the fluid pipes (20, 60) are water pipes.

In some embodiments, a pump for a cooling fluid is present.

In some embodiments, a fluid pipe (20, 60) is guided on each of the field conductors (12) and/or conductors (18).

In some embodiments, a region (19), in which the fluid pipe (20, 60) is externally adjacently guided on the field conductor (12) and/or conductor (18), is axially located between a cooling plate (16) and an axial beginning of the stator/rotor block (8).

In some embodiments, field conductor (12) and conductor (18) are connected by means of a shoe (17) and wherein the fluid pipe (20, 60) is guided along the shoe (17).

In some embodiments, the fluid pipes (20, 60) are connected together in series for at least two of the field conductors (12) or conductors (18).

In some embodiments, the fluid pipe (20, 60) encircles the ring, which the field conductors (12) or the conductors (18) form, at its outer edge or on the inside at its inner edge.

In some embodiments, the fluid pipe (20, 60) is guided along a radially outwardly or inwardly pointing side of the field conductors (12) or conductors (18) and has surface elements (61) adjacent to an azimuthal side of the field conductors (12) or conductors (18).

In some embodiments, the fluid pipe (20, 60) runs, at least in certain sections, parallel to the field conductor (12) or conductor (18).

In some embodiments, the fluid pipe (20, 60) has a ceramic material, in particular is made from a ceramic material.

In some embodiments, the fluid pipe (20, 60) is insulated from the field conductor (12) or conductor (18) by an electrically insulating layer of material.

In some embodiments, the printed circuit boards (15) are circular or ring sector-shaped.

In some embodiments, the cooling plate (16) is arranged perpendicular to the axis (9) of the electric motor (10).

In some embodiments, the electric motor (10) actuates each of the field conductors (12) with a separate phase.

In some embodiments, the inverters are embodied to generate an alternating voltage with an amplitude of 200 v or less, in particular 150 v or less, in particular 50 v or less.

### BRIEF DESCRIPTION OF THE DRAWINGS

The teachings of the present disclosure are described and explained in more detail below with reference to the exemplary embodiments shown in the figures. In the drawings, schematically:

FIG. 1 shows an electric motor incorporating teachings of the present disclosure with three cooling plates for heat dissipation from printed circuit boards in an oblique view;

FIG. 2 shows printed circuit boards incorporating teachings of the present disclosure arranged on a cooling plate in a front view;

FIG. 3 shows a sectional image of the cooling plates with conductor bars and connecting elements;

FIG. 4 shows a side view of conductor bars and cooling plates with an embodiment of fluid channels;

FIG. 5 shows a non-perspective pattern for a series connection of the fluid channels;

FIG. 6 shows a further embodiment for a fluid channel with azimuthal guiding incorporating teachings of the present disclosure.

### DETAILED DESCRIPTION

The electric motors described herein comprise a stator with a plurality of field conductors embodied as bars as well as plurality of inverters for actuating the field conductors. The inverters are arranged on one or more printed circuit board(s). Furthermore, the printed circuit boards are arranged on at least one cooling plate and the cooling plate is arranged in such a way that the field conductors or conductors electrically connected to the field conductors are mechanically operatively connected to the cooling plate, in particular penetrate it. Finally, at least one cooling apparatus is present which comprises a fluid pipe which is externally adjacently guided on one or more of the field conductor(s).

Due to the fluid cooling, the electric motors described herein have improved heat dissipation for the field conductors. As a result, a smaller heat flow reaches the cooling plates and the electronic devices arranged on the cooling plates, in particular the inverters. As a result, the cooling effort in the region of the cooling plates and the electronic devices can in turn be reduced.

In some embodiments, the field conductors or conductors act as mechanical supports for the cooling plates and are therefore mechanically operatively connected to them. It is possible that the field conductors or conductors penetrate the cooling plate and the printed circuit board. In addition to solid bars, the field conductors embodied as bars can also be those which are composed of a plurality of sub-conductors. The sub-conductors can be connected in parallel if the field conductors are, for example, Roebel conductors. The sub-conductors can also be connected in series and the field conductors consist of a plurality of sub-components which are lined up, for example, per welded joint.

The conductors can be arranged to be mechanically fixed to the field conductors and be connected to them, with exactly one field conductor always being connected to exactly one conductor, with the conductors axially extending the field conductors. In this case, the field conductors, conductors and cooling plate form a mechanically rigid unit.

In some embodiments, the fluid pipes can be water pipes. Water is a standard coolant and can be provided, for example in a factory, from outside of the electric motor, so pipes suitable for water are expedient.

In some embodiments, the electric motor can have a pump for a cooling fluid. If the cooling fluid is not supplied from outside, a circulation of fluid can be generated which provides for heat removal due to movement of material. If the motor has a high number of field conductors, for example more than 50 or even more than 100 field conductors, a plurality of pumps can also be present.

In some embodiments, the electric motor can be configured such that a fluid pipe is guided on each of the field conductors and/or conductors. It is expedient for each of the field conductors or conductors to provide heat dissipation since during operation of the electric motor the field conductors or conductors are equally subjected to heat and thus each of the field conductors or conductors contributes approximately equally to the heat transport to the cooling plates.

In some embodiments, a region, in which the fluid pipe is externally adjacently guided on the field conductor and/or conductor, is axially located between a cooling plate and an axial beginning of the stator/rotor block. The field conductors and/or conductors lie freely in this region and the fluid pipe can be attached without problems. Furthermore, it is expedient to remove the heat in this region in order to reduce the heat input from the rotor region, i.e. the drive system in the electronic devices, i.e. the region of the cooling plates and printed circuit boards.

If conductors are present then these are expediently connected to the field conductors by means of a shoe, wherein the fluid pipe is guided along the shoe. The shoe serves as a permanent connection between the field conductors and the conductors, with the field conductors pertaining to the drive side of the electric motor and the conductors making contact with the electronic devices on the printed circuit boards and supporting the cooling plates and printed circuit boards. In some embodiments, the shoe can be geometrically adapted to the fluid pipe without the shape or the cross-section of the field conductors having to be changed. Production of the field conductors is simplified as a result. In some embodiments, the fluid pipe can be externally adjacently guided on a field conductor.

The fluid pipes for at least two of the field conductors or conductors can be connected together in series. In other words, a single fluid pipe leads to one field conductor or conductor and then in succession to at least one further field conductor or conductor. Only thereafter does the fluid pipe lead away from the field conductors, for example to a reservoir. In this way a plurality of the field conductors or conductors are cooled by a single fluid pipe, and this reduces the connection effort.

The fluid pipe can encircle the ring, which the field conductors or the conductors form, at its outer edge or on the inside at its inner edge. In other words, the fluid pipe extends azimuthally beyond at least two of the field conductors or conductors. The fluid pipe can form a complete ring, i.e. touch all field conductors or conductors, or else form only a ring sector in which the fluid pipe extends over some of the field conductors or conductors and thus removes their heat. In the latter case it is expedient to use a plurality of such fluid pipes which together extend over and thus cool all field conductors or conductors. For this it is also expedient to use a fluid pipe for an angular segment or a portion of the field conductors or conductors, which corresponds to a fraction of the full circle with an integral denominator, i.e. ⅓, ¼ or ⅛ of the full circle. For example, in the case of 72 field conductors, ⅙ of them, i.e. 12 could be cooled by one fluid pipe and six such fluid pipes could be present. Each of the fluid pipes would thus cover an angle of 60° of the full circle.

The fluid pipe can be guided along a radially outwardly or inwardly pointing side of the field conductors or conductors and has surface elements adjacent to an azimuthal side of the field conductors or conductors. The surface elements enlarge the contact area between the fluid pipe and the field conductor or conductor and thereby provide for improved heat transfer from field conductor or conductor to the fluid. If the fluid pipes are guided along a radially external side of the field conductors or conductors, the surface element expediently points radially inwards, and vice versa. The surface element can be U-shaped and thus can provide for mechanical retention of the fluid pipe in addition to better thermal contact.

The fluid pipe can run, at least in certain sections, parallel to the field conductor or conductor. In other words, in certain sections it is arranged on the field conductor or conductor such that the fluid channel runs parallel to the field conductor or conductor.

The fluid pipe may comprise a ceramic material, in particular be made from a ceramic material. Ceramic materials are heat-resistant, chemically stable and electrically insulating and therefore allow installation in the electric motor without requiring further measures such as electrical insulation.

The fluid pipe can be electrically insulated from the field conductor or conductor by an electrically insulating layer of material. Insulating pads are examples of this. It is particularly advantageous in this connection again that, owing to its construction, the electric motor operates with relatively low voltages and thus the effort for electrical insulation can be kept comparatively low. The thickness of the layer of material and an additional insulation directed toward the side only have to be adjusted to voltage differences in the region of, for example, 12 V.

The electric motor can have a plurality of printed circuit boards. In particular, a plurality of separate printed circuit boards can be provided on a cooling plate. The power electronics used can be modularized by way of a distribution of a plurality of printed circuit boards. By using a large number of similar printed circuit boards it is thus possible to provide a large number of converters, whereby production in respect of rejects is improved.

The printed circuit boards can be circular or ring sector-shaped. As a result, the printed circuit boards can be arranged in a circle or a ring which encloses the axle of the electric motor. Printed circuit boards with this shape may be assembled to form a circle or ring and thus, optimally adjusted to the shape of the electrical machine, be arranged at an axial end of the machine, with a high modularity simultaneously being achieved. As a result, the printed circuit boards can be compactly arranged axially offset relative to the stator and rotor and form an integral part of the electric motor. In this way it is also possible to arrange a plurality of cooling plates with printed circuit boards axially offset from one another and thus connect inverters, for example, in parallel which are arranged at the same azimuthal location.

In some embodiments, the cooling plate is arranged perpendicularly to the axis of the electric motor. In this way the cooling plate with the printed circuit boards can be compactly arranged at an axial end of the electrical machine. A plurality of cooling plates can also be arranged axially offset and close to one another. Furthermore, with such an arrangement a uniform spacing between cooling plate and power electronics from the bars, which form the field conductors, is given, whereby establishing contact with the bars is simplified.

In some embodiments, each of the field conductors is actuated with a separate phase. A phase is taken to mean an alternating voltage supply which is phase-offset with respect to all other phases used in the electric motor by an angle that is different from zero. In this case, a separate inverter is expediently present for each of the field conductors and actuates only this field conductor.

The inverters can generate an alternating voltage with an amplitude of 200 v or less, in particular 150 v or less, in particular 50 v or less. The voltage generated in this way is the voltage to which the field conductors, i.e. the stator bars, are subjected. This comparatively low voltage makes it possible for the first time for the components of the inverters to be arranged very close to one another. Spacings of approximately 2 mm can be used between the components, such as the power semiconductor switches, resulting in a high packing density of the electronic components and the possibility of arranging a large number of inverters on a comparatively small space. As a result, in the case of a small space requirement it is again possible to use a high number of phases, in particular a number of phases which corresponds to the number of stator bars. With an appropriately high number of stator bars it is thus possible to use 48, 72 or even 120 phases.

The terms “axial”, “radial” and “azimuthal” refer here to the axis of the rotor and therewith to the corresponding axis of symmetry of the stator. Here, “axial” describes a direction parallel to this axis, “radial” describes a direction orthogonal to the axis, towards or away from it, and “azimuthal” is a direction which is directed at a constant radial distance from the axis and at a constant axial position circularly around the axis.

When the terms “axial”, “radial” and “tangential” are used with reference to a surface, for example a cross-sectional surface, the terms describe the orientation of the normal vector of the surface, i.e. of that vector which is perpendicular to the surface concerned.

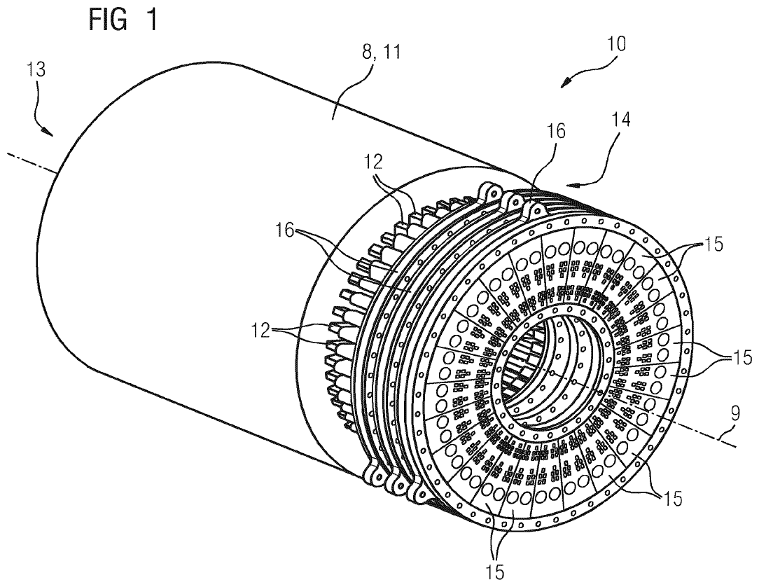

FIG. 1 represents an isometric view of an electric motor 10 incorporating teachings of the present disclosure. The electric motor 10 comprises a stator 11 and a rotor which is arranged substantially in the stator 11 and is not visible in FIG. 1. The rotor is connected in a rotationally fixed manner to a shaft, which is likewise not represented in FIG. 1. By electromagnetic interaction of the rotor with a stator 11 energized with current, the rotor is set in rotation about an axis 9. The rotor is separated from the stator 11 by an air gap.

In some embodiments, the electric motor 10 can also be an external rotor motor or bell-type armature motor.

The stator 11 comprises a plurality of rigid and straight conductor bars 12 as field conductors. On the end face 13 which is averted in FIG. 1, these conductor bars 12 are connected together by a short-circuit ring. On the rear side 14 of the electric motor 10, the conductor bars 12 are individually fed by respectively associated inverter modules. Since, due to the conductor bars 12, an electric motor 10 operated at low voltages is involved, the inverter modules together with other components of the electronic devices (DC/DC converters, rectifiers) can be arranged relatively close together on printed circuit boards 15. In this example, the printed circuit boards are in the form of ring sectors and many individual printed circuit boards 15 together form an annular printed circuit board structure.

While it is assumed in the examples that the boards 15 support inverter modules, it is also possible that some of the boards 15 support rectifiers and DC/DC converters.

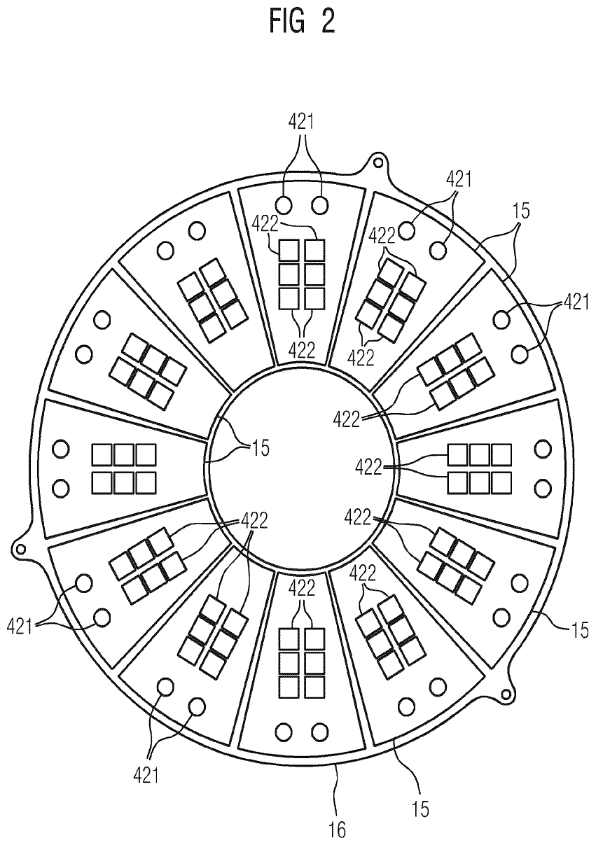

FIG. 2 shows a plan view of such a circuit board structure. The number of circuit boards shown in FIG. 2 is reduced and greatly simplified compared with the illustration in FIG. 1 for better clarity. The specific number of such circuit boards 15 depends on the specific embodiment of the electric motor 10, in particular the number of conductor bars 12. Each of the printed circuit boards 15 comprises a plurality of semiconductor switches 422.

Further, some of the printed circuit boards 15 or all of the printed circuit boards 15 can comprise driver circuits not represented in the figures and other electronic components such as capacitors. The semiconductor switches 422 are power semiconductors such as IGBTS, MOSFETS, or JFETS, and can additionally comprise diodes (not shown) depending on the interconnection. The semiconductor switches 422 are connected, for example, as half bridges. A capacitor (not shown) can constitute, for example, an intermediate circuit capacitor of the half bridges. The semiconductor switches 422 of a circuit board 15 can be assigned to a single phase or else to a plurality of phases.

The printed circuit boards 15 furthermore comprise contact points 421 to which the conductor bars 12 are connected. The printed circuit boards 15 are supported by disk-shaped cooling plates 16, it being possible for the cooling plates 16 to be occupied on both sides with printed circuit boards 15 for a better use of space.

Since relatively high currents are necessary in the conductor bars in the electric motor 10, a plurality of inverters may be connected in parallel for the energization thereof. This can be achieved, for example, by the six circuit board structures shown in FIG. 1 on three cooling plates 16 all being connected in the same way to the conductor bars 12 and thus being connected electrically in parallel. In this case, use is made of the fact that the conductor bars 12 or connecting elements to the conductor bars 12 penetrate the cooling plates 16 and therewith also the printed circuit boards 15 in the same way at the contact points or at least contact them in the case of the outermost cooling plate 16.

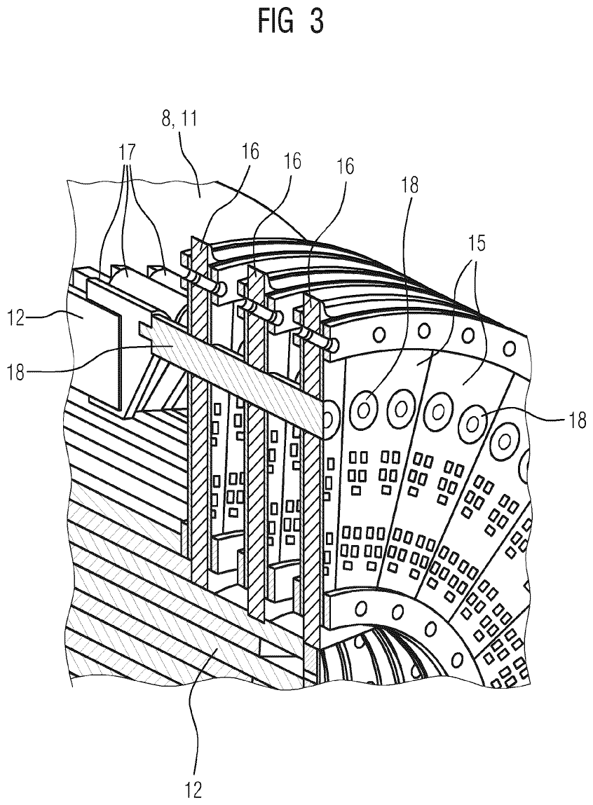

FIG. 3 shows a sectional image of the electric motor 10 in an oblique view. It can be seen here that the connecting elements 18 mechanically support the three cooling plates 16 and penetrate them. The connecting elements 18 are connected to the conductor bars 12 by shoes 17. The inverters, which are located on the printed circuit boards in the regions in which one of the connecting elements 18 penetrates a cooling plate 16, are connected in parallel and together provide the current for the current bar 12.

The stator/rotor block 8 of the electric motor 10 and the electronic devices on the printed circuit board generate heat. In addition to the electrical conduction, the conductor bars 12 and the connecting elements 18 also constitute a heat bridge between the two components. However, it is important, particularly on the electronic device side, that there is not an additional excessive input of heat since the electronic components must not greatly exceed a temperature of approximately 80° C. for long. Intensified cooling in the region of the printed circuit boards is expensive, however.

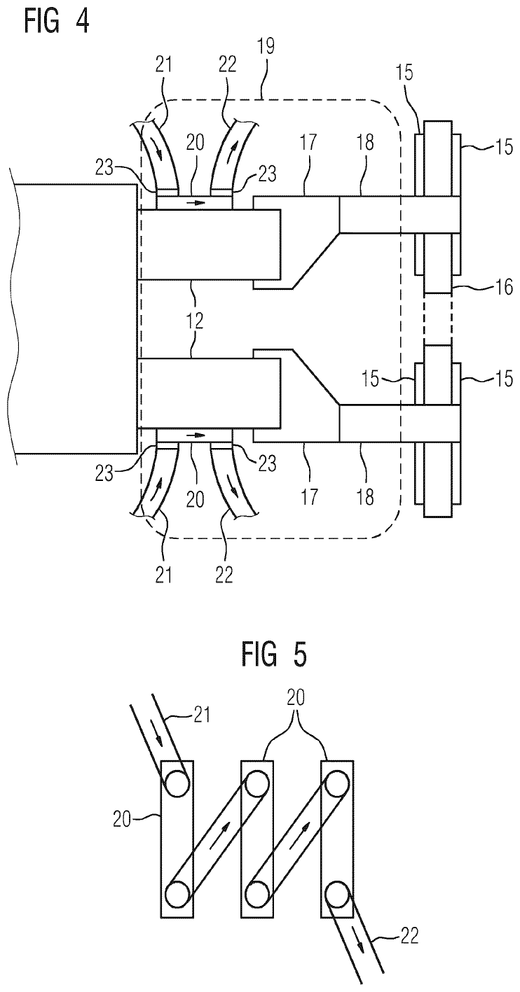

It may therefore be advantageous to provide cooling in the region 19 between the cooling plates 16 and the stator/rotor block 8. FIG. 4 shows such a type of cooling at a conductor bar 12. In the case of the cooling provided in FIG. 4, a fluid channel 20 is attached to the conductor bar 12 such that the water, which is used here as the cooling fluid, is guided along the conductor bar 12 via a distance in the region of a few cm. The volume of heat, which can pass from the conductor bar 12 to the fluid channel 20 and therewith the water, can be adjusted over the length of this distance since a longer distance produces a larger contact surface and the latter a greater flow of energy.

The fluid channel 20 can be, for example, ceramic. In this case, it is rigid in the manner of ceramic materials. A hose connection 23 can therefore be present at both ends, into which connection a hose leads for continued water supply. An inlet 21 and an outlet 22 are implemented as a result. These hoses can be brought together at a different point in order to implement a cooling circuit. At this point the heat can be emitted to the surroundings via a heat exchanger or heat sink. It is possible that said elements are designed as part of the electric motor 10. In some embodiments, it is also possible that the cooling circuit is already present, independently of the electric motor 10, at the installation site of the electric motor 10 and the electric motor 10 is connected to it together with other devices.

In some embodiments, the fluid channel can also be manufactured from other materials, also, for example, metallic materials. In this case, an electrical line from the conductor bar 12 to other elements should be avoided, for example by using plastics material hoses for supplying water.

Since all conductor bars 12 are heated equally by the side of the stator/rotor block 8 and are connected equally to the printed circuit boards 15, it is expedient to provide a fluid channel 20 for each of the conductor bars 12. In particular embodiments of the electric motor 10, the number of conductor bars 12 is high, however, for example 48, 72 or even 120. In the latter case, there are thus 120 outlets 22 and 120 inlets 21 which have to be connected or brought together at a different point and have to be reached for a flow of water, for example by way of a pump system.

For particular embodiments of the electric motor 10 it is therefore advantageous to combine fluid channels 20 that are close together into groups and to connect them in series. FIG. 5 schematically represents such an embodiment. It is also assumed that the fluid channels 20 are arranged directly on the conductor bars 12. However, in order to simplify the representation, FIG. 5 shows neither the conductor bars 12 nor the actually three-dimensional, annular arrangement of the fluid channels 20, but instead represents the fluid channels 20 side by side in a simplified manner.

According to FIG. 5, three fluid channels 20 are combined to form a group and are connected in series in respect of the flow of water. If this grouping is applied in an electric motor 10 with 120 conductor bars 12 for all conductor bars 12, 40 such groups result and therefore 40 inlets 21 and 40 outlets 22, i.e. far fewer than before. By forming larger groups the effort in respect of guiding the cooling fluid can be reduced further as long as the cooling capacity for the respectively last conductor bars 12 remains sufficiently high in the series of fluid channels.

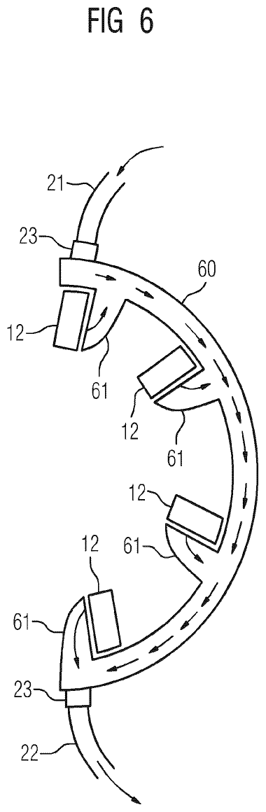

In the embodiment according to FIG. 5, the flow of water still runs, in certain sections, parallel to the orientation of the conductor bars 12. In some embodiments, which is represented in FIG. 6, the orientation of the flow of water is rotated by 90° and the water is distanced azimuthally around the ring which is embodied by the conductor bars 12. FIG. 6 shows the thus formed fluid channel 60. The fluid channel 60 rests on four of the conductor bars 12 over its course. According to FIG. 6, this does not correspond to all conductor bars 12, but only to some of the conductor bars 12. A similar consideration can take place in the formation of the groups in FIG. 5. The more conductor bars 12 that extend over the fluid channel 60, the simpler installation and connection are since the number of inlets 21 and outlets 22 reduces. On the other hand, the potential cooling capacity reduces, however. Furthermore, for assembly purposes it can be simpler in this case with a rigid fluid channel 60 if it does not form a complete ring, i.e. only extends over some of the conductor bars 12.

Since in the fluid channel 60 in the exemplary embodiment in FIG. 6 the water does not flow along the longitudinal extension of the conductor bars 12, the distance, which is available for the delivery of water, and therewith also the surface, is shorter than in the embodiments of FIGS. 4 and 5. To guarantee an adequate heat transfer the fluid channel 60 can have additional surface- expanding elements 61. These appear tooth-shaped in FIG. 6 and are made of full material to enable good heat conduction. In other words, they do not constitute an additional volume for the cooling fluid but instead expand the surrounding material such that an enlarged surface which touches the conductor bars 12 results.

Electrical insulation is automatically provided when plastics material hoses are used for the transverse joint between the fluid channels. The fluid channel 60, by contrast, can also be designed as an integral component. If it is then made from an insulating material, for example a ceramic, insulation is then still provided between the conductor bars 12. If the fluid channel 60 is metallic, by contrast, then insulation is necessary to prevent a cross circuit of the conductor bars 12. For this purpose insulation pads can be arranged between the fluid channel 60 and optionally the additional surface elements 61 and the conductor bar 12.

In the preceding exemplary embodiments, the fluid channel 20, 60 is always guided along the surface of the conductor bars 12. In all embodiments the fluid channel 20, 60 can be guided equally as well along the connecting elements 18 and heat thus dissipated from the connecting elements 18.

A further possibility, which can be substituted in all exemplary embodiments, is to guide the fluid channel 20, 60 along the shoes 17 with which the connecting elements 18 and the conductor bars 12 are connected together. This is advantageous to the extent that the shoes are typically already embodied to connect the conductor bars 12 and connecting elements 18 which are different in terms of their cross-sectional shape and therefore have more complex shapes themselves than the conductor bars 12 or the connecting elements 18. It is therefore possible to take account of and compensate for a reduction in the conductive cross-section, which result[s] due to holes, in the construction of the shoes 17 without problems. Both the conductor bars 12 and the connecting elements 18 can thereby have a uniform construction again and thereby be easier to produce.

### LIST OF REFERENCE NUMERALS

8 stator/rotor block
9 motor axis
10 electric motor
11 stator
12 conductor bars
13 end face
14 rear side
15 printed circuit board
16 cooling plate
17 shoe
18 connecting element
19 region
20, 60 fluid channel
21 inlet
22 outlet
23 hose connections
61 additional surface element
421 contact points
422 semiconductor switch

What is claimed is:

1. An electric motor comprising:
a stator having a plurality of bar-shaped field conductors;
a plurality of inverters for actuating the field conductors;
wherein
the inverters are arranged on one or more printed circuit boards arranged on at least one cooling plate;
wherein the at least one cooling plate is mechanically connected to the field conductors or conductors electrically connected to the field conductors;
and
a cooling apparatus including a fluid pipe externally adjacently guided on one or more of the field conductors.

2. The electric motor as claimed in claim 1, wherein the fluid pipes comprise water pipes.

3. The electric motor as claimed in claim 1, further comprising a pump delivering a cooling fluid to the cooling apparatus.

4. The electric motor as claimed in claim 1, wherein a fluid pipe is guided on each of the field conductors and/or conductors.

5. The electric motor as claimed in claim 1, wherein a region in which the fluid pipe is externally adjacently guided on the field conductor and/or conductor is axially located between a cooling plate and an axial beginning of the stator/rotor block.

6. The electric motor as claimed in claim 1, wherein the field conductor and conductor are connected by a shoe and wherein the fluid pipe is guided along the shoe.

7. The electric motor as claimed in claim 1, wherein the fluid pipes are connected together in series for at least two of the field conductors or conductors.

8. The electric motor as claimed in claim 1, wherein the fluid pipe encircles a ring formed by the field conductors or the conductors form, at an outer edge or on the inside at an inner edge.

9. The electric motor as claimed claim 8, wherein the fluid pipe is guided along a radially outwardly or inwardly pointing side of the field conductors or conductors and has surface elements adjacent to an azimuthal side of the field conductors or conductors.

10. The electric motor as claimed in claim 1, wherein the fluid pipe runs, at least in certain sections, parallel to the field conductor or conductor.

11. The electric motor as claimed in claim 1, wherein the fluid pipe comprises a ceramic.

12. The electric motor as claimed in claim 1, wherein the fluid pipe is insulated from the field conductor or conductor by an electrically insulating layer of material.

13. The electric motor as claimed in claim 1, wherein the printed circuit boards are circular or ring sector-shaped.

14. The electric motor as claimed in claim 1, wherein the cooling plate is arranged perpendicular to the axis of the electric motor.

15. The electric motor as claimed in claim 1, operable to actuate each of the field conductors with a separate phase.

16. The electric motor as claimed in claim 1, wherein the inverters generate an alternating voltage with an amplitude of 200 v or less.
